(19) United States
(12) Patent Application Publication
(10) Pub. No.: US 2026/0202262 A1
(43) Pub. Date: Jul. 16, 2026

(54) DEVICE, SYSTEM AND METHOD FOR PROVIDING FLUID TEMPERATURE VALUE AND VEHICLE COMPRISING THE SYSTEM

(71) Applicant: NORMA GERMANY GMBH, Maintal (DE)

(72) Inventors: Cheng XU, Wuxi (CN); Daniel KINTEA, Groß-Umstadt (DE); David SCHNEIDER, Darmstadt (DE); Gerrit VON BREITENBACH, Karlstein am Main (DE)

(21) Appl. No.: 19/133,850

(22) PCT Filed: Nov. 24, 2023
(86) PCT No.: PCT/IB2023/061858

§ 371 Date: May 29, 2025

(30) Foreign Application Priority Data
Nov. 30, 2022 (CN) 202211514151.X

(51) Int. Cl. G01K 13/02; G01K 1/02; G01K 1/16

(52) U.S. Cl. CPC G01K 13/02; G01K 1/026; G01K 1/16

(57) ABSTRACT

A device, a system and a method for providing at least one fluid temperature value of a fluid flowing in a line and a vehicle including the system are disclosed. The device includes an input, a processing unit and an output. The input is configured to receive a first temperature signal providing at least one first temperature value from a first sensor abutting a first heat conducting element at the line, the first heat conducting element extending to the fluid in the line. The output is configured to provide an output signal comprising at least one fluid temperature value. The processing unit is configured to perform multiple steps.

### FIELD

The disclosure relates to a device, a system and a method for providing a at least one fluid temperature value of a fluid flowing in a line and a vehicle comprising the system.

### DISCUSSION OF THE BACKGROUND

Measuring the temperature of a fluid in a line or quick connector comes with several challenges as many boundary conditions have to be satisfied, simultaneously. For high accuracy and fast measuring responses, the sensor should be arranged as close as possible to the fluid. Best results are achieved when the sensor is submerged in the liquid flow. However, this may lead to pressure losses which are not desired.

It is known to use an insulated temperature sensor which is arranged at a wall of a line to measure the temperature of the fluid flow inside the line. The insulated temperature sensor delivers temperature data from the wall being in thermal contact with the fluid. However, the deviation from those temperature data to the real fluid temperature is high. Furthermore, the temperature data lags behind the real fluid temperature if the fluid temperature varies.

### SUMMARY

Therefore, an object per an embodiment is to provide a device and a method providing more accurate fluid temperature values.

In an embodiment, a device for providing a at least one fluid temperature value of a fluid flowing in a line is provided, the device comprising: an input, a processing unit and an output, wherein the input is configured to receive a first temperature signal providing at least one first temperature value from a first sensor abutting a first heat conducting element at the line, the first heat conducting element extending to the fluid in the line, wherein the output is configured to provide an output signal comprising at least one fluid temperature value, and wherein the processing unit is configured to perform at least the following steps: receiving the first temperature signal from the input; determining the at least one fluid temperature value from the first temperature value using a second temperature value representing a temperature of the ambient air of the line; and providing an output signal comprising the at least one fluid temperature value.

According to an embodiment, the device provides an estimation of the fluid temperature value that is based on the temperature measured at the first heat conducting element on the line and the ambient air temperature. The first heat conducting element may for example be a wall of the line or an element, e.g. a metal sleeve inserted in the line, extending from the first temperature sensor to the fluid in the line such that the first heat conducting element is in direct contact with the fluid. In both cases, the first sensor does not have direct contact with the fluid. The input of the device may for example be electrically connected to the first sensor that abuts the first heat conducting element of the line. Furthermore, the first sensor may for example be thermally insulated to the ambient air, such that the first sensor provides temperature data measured at the first heat conducting element with minimal heat exchange with the ambient air. The first temperature signal comprises those temperature data. The second temperature value represents the temperature of the ambient air of the line. The second temperature value is not necessarily the temperature of the ambient air but may also be a temperature value being closer to the temperature of the ambient air than the measurements of the first sensor or the second temperature value may be an estimated temperature value. The representation of the temperature of the ambient air may for example mean that the second temperature value may be stored as an estimated temperature value in a memory of the processing unit or may be determined from or provided by a second temperature signal received at the input. In the latter case, the second temperature value representing the temperature of the ambient air may for example be derived from a second sensor providing a second temperature signal that is more influenced by the temperature of the ambient air than the first sensor. Thus, the second sensor may directly measure the temperature of the ambient air or may for example at least be in contact with the ambient air while being influenced by the temperature of the line and/or the fluid. The processing unit uses the temperature data from the first temperature signal and the second temperature value to determine the fluid temperature value. Then, the processing unit may provide those fluid temperature values to the output. That determination is an estimation of the real fluid temperature in the line. Furthermore, that estimation of the fluid temperature value is closer to the real fluid temperature and more accurate than the values of the first temperature signal alone due to the consideration of the second temperature value.

According to an example, the second temperature value may be determined from at least one second temperature signal from a second sensor directly measuring the temperature of the ambient air of the line, preferably per an embodiment abutting the line or a first or second heat conducting element of the line, and being in thermal contact to the ambient air of the line.

Then, the input may be configured to receive the second temperature signal to provide the second temperature signal to the processing unit. If the at least one second sensor directly measures the temperature of the ambient air, the second sensor may for example be a temperature sensor of another device. The second sensor just requires thermal contact to air having the same temperature as the ambient air of the line. If the second sensor is attached to or abuts a second heat conducting element of the line, the second sensor is not thermally insulated against the ambient air of the line. The second heat conducting element may be integral to the first heat conducting element. Thus, in both cases, the temperature of the ambient air influences the temperature measurement of the second sensor more than the temperature measurement of the thermally insulated first sensor. Furthermore, in both cases the second temperature value represents the temperature of the ambient air without necessarily being the temperature of the ambient air.

According to a further example, the processing unit may further be configured to determine the at least one fluid temperature value based on the second temperature value and at least based on a heat accumulation rate in the first sensor.

If the second temperature value is determined from a second temperature signal of a second sensor e.g. directly measuring the air temperature or if the second temperature value is an estimated value e.g. being stored in the memory of the processing unit, the heat accumulation may be considered. This may be performed with a conventional heat transfer model using the equation:

$$\frac{( \text{?} - \text{?} )}{\text{?}} - \frac{( \text{?} - \text{?} )}{\text{?}} = \frac{\text{?}}{\text{?}} + \text{?} \text{?} + \frac{\text{?}}{\text{?}} = Q 1 \qquad ( 1 )$$

$$\text{?} \text{indicates text missing or illegible when filed}$$

wherein Tf is the fluid temperature value, Ts1 is the first temperature value, R1 is the heat resistance of the first heat conducting element of the line, Te is the temperature of the ambient air of the line, Ri is the heat resistance of the thermally insulating element of the first sensor, Rc1 is the heat resistance of the air convection of the ambient air, \dot{Q}_{wall1} is the heat accumulation rate in the first heat conducting element abutting the first sensor, \dot{Q}ₛₑₙₛₒᵣ₁ is the heat accumulation rate of the first sensor, is the heat accumulation rate of the thermally insulating element, and Q1 is the total heat accumulation rate at the location of the first sensor. Since in the model R1, Ri, Rc1, and Q1 are known or may be determined, the fluid temperature value may be determined by reverse calculation.

If the second temperature value results from a second temperature signal from a second sensor abutting a second heat conducting element of the line and being thermally non-insulated, the temperature of the ambient air may be determined with the conventional heat transfer model before determining the fluid temperature value using the following equation or by including the following equation in equation (1) without expressly determining the temperature of the ambient air:

$$\frac{( \text{?} - \text{?} )}{\text{?}} - \frac{( \text{?} - \text{?} )}{\text{?}} = \frac{\text{?}}{\text{?}} + \text{?} \text{?} + \frac{\text{?}}{\text{?}} = Q 2 \qquad ( 2 )$$

$$\text{?} \text{indicates text missing or illegible when filed}$$

wherein Tf is the fluid temperature value, Ts2 is the second temperature value, R2 is the heat resistance of the second heat conducting element of the line, Te is the temperature of the ambient air of the line, Rc is the heat resistance of the air convection of the ambient air, \dot{Q}_{wall2} is the heat accumulation of the second heat conducting element abutting the second sensor, is the heat accumulation rate of the second sensor, and Q2 is the total heat accumulation rate at the location of the second sensor. In the model, R2, Rc2, and Q2 are known or may be determined.

According to another example, the second temperature value may be an estimated value.

In that case, the second temperature value may for example be estimated to be constant. Then, the second temperature value may for example be stored in a memory of the processing unit or in a memory external of the processing unit. The estimated temperature value may be provided as the second temperature signal to the input. Alternatively, the second temperature value may be estimated based on the geographic position of the device and the actual date and time.

For example, the processing unit may further be configured to provide the first temperature value and the second temperature value to an artificial neural network, wherein an output layer of the artificial neural network provides the at least one fluid temperature value. The first and second temperature signal may be directly or indirectly provided to the artificial neural network, e.g. by processing like normalization and differentiation, to provide the first and second temperature values.

The first temperature value and the second temperature value may be provided to the input layer of an appropriately trained artificial neural network. The artificial neural network may for example comprise at least one hidden layer with preferably 2 to 10, more preferably 3 to 8, even more preferably 4 to 6, most preferred 5 Sigmoid nodes, per various embodiments. However, different numbers of nodes, different node types, or improved structure may be used to achieve better results. The training of the artificial neural network may be performed using an appropriate data set.

According to a second embodiment, a system for providing a at least one fluid temperature value of a fluid flowing in a line is provided, the system comprising at least one line for transporting a fluid, at least one device according to the above description, at least one first sensor being attached to a first heat conducting element of the line and being arranged between the first heat conducting element and at least one thermally insulating element shielding the at least one first sensor from the ambient air, wherein the first sensor is electrically connected to the input of the device.

The effects and further embodiments of the system may be analogous to the effects and embodiments of the device according to the description mentioned above. Thus, it is referred to the above description of the device.

In an example, the device may be integrated into the line, e.g. the wall of the line close to the first sensor.

According to an example, the system further comprises a second sensor preferably per an embodiment being attached to the second heat conducting element of the line, wherein the second sensor is in contact with the ambient air of the line.

According to a third embodiment, a vehicle is provided comprising at least one fluid line and at least one system according to the description mentioned above, wherein the line is connected to the fluid line.

The effects and further embodiments of the vehicle may be analogous to the effects and embodiments of the device and the system according to the description mentioned above. Thus, it is referred to the above description of the device and the system.

In an example, the output may be connected to the coolant circulation control of an electric vehicle, particularly of an electric car. Alternatively, the processing unit may be a control unit of the vehicle.

According to a fourth embodiment, a computer implemented method for providing a at least one fluid temperature value of a fluid flowing in a line is provided, the method comprising at least the following steps: receiving a first temperature signal providing at least one first temperature value from a first sensor abutting a first heat conducting element at the line, the first heat conducting element extending to the fluid in the line; determining the at least one fluid temperature value from the first temperature value using a second temperature value representing a temperature of the ambient air of the line; and providing an output signal comprising the at least one fluid temperature value.

According to an embodiment, the method provides an estimation of the fluid temperature value that is based on the temperature measured at the first heat conducting element of the line and the ambient air temperature. Thus, the first sensor provides temperature data measured at the first heat conducting element with minimal heat exchange with the ambient air. The first temperature signal comprises those temperature data. The second temperature value represents the temperature of the ambient air of the line. The second temperature value is not necessarily the temperature of the ambient air but may also be a temperature value being closer to the temperature of the ambient air than the measurements of the first sensor or the second temperature value may be an estimated temperature value. The representation of the temperature of the ambient air may for example mean that the second temperature value may be an estimated temperature value or may be determined from or provided by a second temperature signal. In the latter case, the second temperature value representing the temperature of the ambient air may for example be derived from a second sensor providing a second temperature signal that is more influenced by the temperature of the ambient air than the first sensor. Thus, the second sensor may directly measure the temperature of the ambient air or may for example at least be in contact with the ambient air while being influenced by the temperature of the line and/or the fluid. The method uses the temperature data from the first temperature signal and the second temperature value to determine the fluid temperature value. Then, the method may provide those fluid temperature values. That determination is an estimation of the real fluid temperature in the line. Furthermore, that estimation of the fluid temperature value is closer to the real fluid temperature and more accurate than the values of the first temperature signal alone due to the consideration of the second temperature value.

Further effects and further embodiments of the method may be analogous to the effects and embodiments of the device according to the description mentioned above. Thus, it is referred to the above description of the device.

According to an example, the second temperature value is determined from at least one second temperature signal from a second sensor directly measuring the temperature of the ambient air of the line, preferably per an embodiment abutting the line or the first or second heat conducting element of the line, and being in thermal contact to the ambient air of the line.

If the at least one second sensor directly measures the temperature of the ambient air, the second sensor may for example be a temperature sensor of another device. The second sensor just requires thermal contact to air having the same temperature as the ambient air of the line. If the second sensor is attached to or abuts a second heat conducting element of the line, the second sensor is not thermally insulated against the ambient air of the line. The second heat conducting element may be integral to the first heat conducting element. Thus, in both cases, the temperature of the ambient air influences the temperature measurement of the second sensor more than the temperature measurement of the thermally insulated first sensor. Furthermore, in both cases the second temperature value represents the temperature of the ambient air without necessarily being the temperature of the ambient air.

According to an example, the at least one fluid temperature value is determined based on the second temperature value and at least based on a heat accumulation rate in the first sensor.

If the second temperature value is determined from a second temperature signal of a second sensor e.g. directly measuring the air temperature or if the second temperature value is an estimated value e.g. being stored in the memory of the processing unit, the heat accumulation may be considered. This may be performed with a heat transfer model using the equation:

$$\frac{( \text{?} - \text{?} )}{\text{?}} - \frac{( \text{?} - \text{?} )}{\text{?}} = \frac{\text{?}}{\text{?}} + \text{?} \text{?} + \frac{\text{?}}{\text{?}} = Q 1 \qquad ( 1 )$$

$$\text{?} \text{indicates text missing or illegible when filed}$$

wherein Tf is the fluid temperature value, Ts1 is the first temperature value, R1 is the heat resistance of the first heat conducting element of the line, Te is the temperature of the ambient air of the line, Ri is the heat resistance of the thermally insulating element of the first sensor, Rc1 is the heat resistance of the air convection of the ambient air, \dot{Q}_{wall1} is the heat accumulation rate in the first heat conducting element abutting the first sensor, \dot{Q}ₛₑₙₛₒᵣ₁ is the heat accumulation rate of the first sensor, Qᵢₙₛᵤₗₐₜᵢₒₙ is the heat accumulation rate of the thermally insulating element, and Q1 is the total heat accumulation rate at the location of the first sensor. Since in the model R1, Ri, Rc1, and Q1 are known or may be determined, the fluid temperature value may be determined by reverse calculation.

If the second temperature value results from a second temperature signal from a second sensor abutting a second heat conducting element of the line and being thermally non-insulated, the temperature of the ambient air may be determined with the conventional heat transfer model before determining the fluid temperature value using the following equation or by including the following equation in equation (1) without expressly determining the temperature of the ambient air:

$$\frac{( \text{?} - \text{?} )}{\text{?}} - \frac{( \text{?} - \text{?} )}{\text{?}} = \frac{\text{?}}{\text{?}} + \text{?} \text{?} + \frac{\text{?}}{\text{?}} = Q 2 \qquad ( 2 )$$

$$\text{?} \text{indicates text missing or illegible when filed}$$

wherein Tf is the fluid temperature value, Ts2 is the second temperature value, R2 is the heat resistance of the second heat conducting element of the line, Te is the temperature of the ambient air of the line, Rc2 is the heat resistance of the air convection of the ambient air, \dot{Q}_{wall2} is the heat accumulation of the second heat conducting element abutting the second sensor, \dot{Q}ₛₑₙₛₒᵣ₂ is the heat accumulation rate of the second sensor, and Q2 is the total heat accumulation rate at the location of the second sensor. In the model, R2, Rc2, and Q2 are known or may be determined.

According to an example, the second temperature value is an estimated value.

In that case, the second temperature value may for example be estimated to be constant. Then, the second temperature value may for example be stored in a memory of the processing unit or in a memory external of the processing unit. The estimated temperature value may be provided as the second temperature signal to the input. Alternatively, the second temperature value may be estimated based on the geographic position of the device and the actual date and time.

According to an example, in the step determining the at least one fluid temperature value, the first temperature value and the second temperature value are provided to an artificial neural network, wherein an output layer of the artificial neural network provides the at least one fluid temperature value. The first and second temperature signal may be directly or indirectly provided to the artificial neural network, e.g. by processing like normalization and differentiation, to provide the first and second temperature values.

The first temperature value and the second temperature value may be provided to the input layer of an appropriately trained artificial neural network. The artificial neural network may for example comprise at least one hidden layer with preferably 2 to 10, more preferably 3 to 8, even more preferably 4 to 6, most preferred 5 Sigmoid nodes. However, different numbers of nodes, different node types, or improved structure may be used to achieve better results. The training of the artificial neural network may be performed using an appropriate data set.

### BRIEF DESCRIPTION OF THE DRAWINGS

Further features, details and advantages of the invention result from the wording of the claims as well as from the following description of exemplary embodiments based on the drawings. The figures show:

FIG. 1a, b a schematic drawing of a system with the device;

FIG. 2 a schematic drawing of another example of the system with the device;

FIG. 3 a flow chart of the method;

FIG. 4 a vehicle comprising the system;

FIG. 5a, b a diagram showing a first example of input and output data of the device;

FIG. 6a, b a diagram showing a second example of input and output data of the device; and

FIG. 7a, b a diagram showing a third example of input and output data of the device.

List of reference signs

| | | | |
|---|---|---|---|
| 10 | device | 12 | input |
| 14 | processing unit | 16 | output |
| 18 | signal line | 18′ | signal line |
| 20 | system | 22 | line |
| 24 | thermally insulating | 26 | first sensor |
| | element | | |
| 28 | second sensor | 30 | first heat conducting |
| | | | element |
| 34 | external sensor | 40 | diagram |
| 42 | real fluid temperature | 44 | first temperature |
| | values | | values |
| 46 | second temperature | 48 | determined fluid |
| | values | | temperature values |
| 50 | ambient air temperature | 60 | vehicle |
| | values | | |
| 62 | control unit | 64 | signal line |
| 66 | signal line | | |

### DETAILED DESCRIPTION OF THE ILLUSTRATED EMBODIMENTS

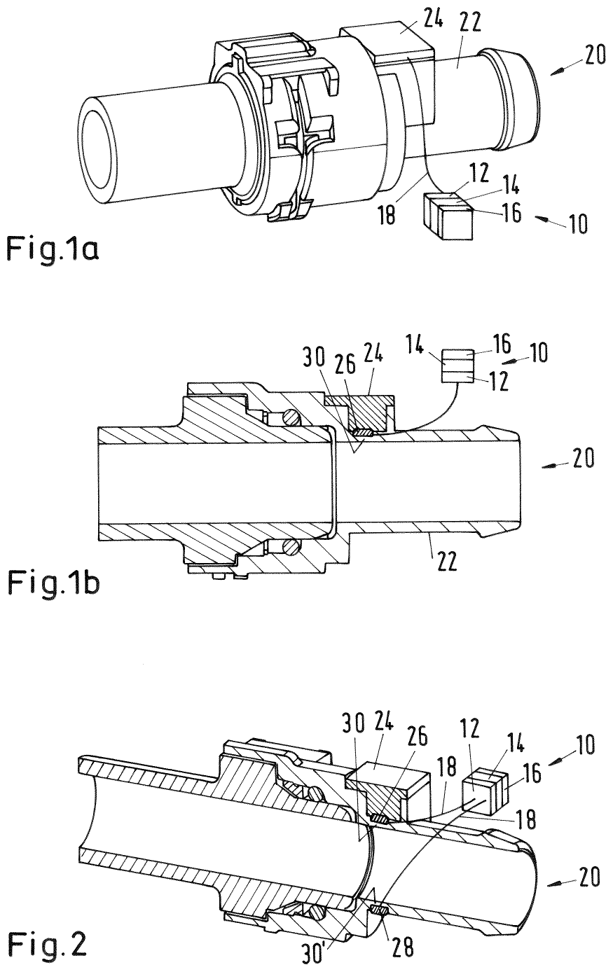

FIG. 1a shows an example of the system 20 for providing a at least one fluid temperature value of a fluid flowing in a line. The system 20 comprises a line 22, a thermally insulating element 24, and a device 10 for providing a at least one fluid temperature value of a fluid flowing in a line. The device 10 comprises an input 12, a processing unit 14, and an output 16.

As shown in FIG. 1b showing a sectional view of FIG. 1a, the thermally insulating element 24 covers a first sensor 26 that is attached to the first heat conducting element 30 of the line 22. In this example, the first heat conducting element 30 is a wall of the line 22. Thus, the first sensor 26 is sandwiched between the insulating element 24 and the first heat conducting element 30. Furthermore, the first sensor 26 has not direct contact to ambient air of the line 22. The thermally insulating element 24 thermally insulates the first sensor 26 from the ambient air.

The first heat conducting element 30 may, for example, also be a metal sleeve extending from the first sensor 26 to the fluid in the line 22.

The first sensor 26 is configured to acquire first temperature values and to provide those values in a first temperature signal. The first temperature signal may comprise a plurality of first temperature values being acquired at different points of time.

Furthermore, the first sensor 26 may continuously provide first temperature values and may continuously provide those values in a continuous first temperature signal. Alternatively, the first sensor 26 only provides single or sets of first temperature values at predefined points of time.

The input 12 of the device 10 is configured to receive the first temperature signal. The input 12 may be electrically connected to the first sensor 26 via a first signal line 18. Alternatively, the input 12 may receive the first temperature signal via a wireless connection.

The processing unit 14 is configured to receive the first temperature signal from the input 12. Furthermore, the processing unit 14 is configured to extract the first temperature values from the first temperature signal.

The processing unit 14 is further configured to determine at least one fluid temperature value. For that determination, the processing unit 14 uses a second temperature value representing a temperature of the ambient air of the line 22. The second temperature value is not necessarily the temperature of the ambient air but may also be a temperature value being closer to the temperature of the ambient air than the measurements of the first sensor or the second temperature value may be an estimated temperature value.

In a first embodiment, the second temperature value may be provided via a second temperature signal. The input 12 may be configured to receive that second temperature signal via a second signal line 18′ or via a wireless connection.

In that embodiment, an external sensor 34 may directly measure the temperature of the ambient air of the line 22. That external sensor 34 may for example be a sensor of a vehicle. The input 12 may be configured to receive the second temperature signal from the external sensor 34. In that first embodiment, the second temperature signal comprises the second temperature values.

In a second embodiment, the second temperature value may be an estimated temperature of the ambient air. In that embodiment, the second temperature value may be stored in a memory, for example an internal memory of the processing unit 14 or an external memory, e. g. a memory of the vehicle. If the second temperature value is stored in an external memory, the input 12 may be configured to receive a second temperature signal from an output of the external memory.

In a third embodiment, the system 20 may comprise a second sensor 28, being attached to the second heat conducting element 30′ of the line 22 as shown in FIG. 2. The second heat conducting element 30′ may also be the wall of the line 22. Furthermore, the second heat conducting element 30′ may be integral with the first heat conducting element 30. The second sensor 28 has direct contact to the ambient air of the line 22. Thus, the second sensor 28 is not thermally insulated to the ambient air. If the ambient air has an air temperature being different to the temperature of the second sensor 28, a heat flow occurs between the second sensor 28 and the ambient air.

In that embodiment, the second sensor 28 may provide the second temperature value to the input 12.

Furthermore, the processing unit 14 may use a model algorithm to determine a temperature of the ambient air from the second temperature values of the second temperature signal. The processing unit 14 may then determine temperature values of the ambient air using the second temperature values of the second temperature signal in equation (2), wherein R1, Rc1, and Q2 are known.

For the determination of the fluid temperature values, the processing unit 14 may use the temperature values of the ambient air in equation (1) in the three embodiments mentioned above. While R1, Ri, Rc1, and Q1 are known or may be determined, the fluid temperature values may be determined by reverse calculation from equation (1).

Alternatively the processing unit 14 may directly determine the fluid temperature values using the second equation (2) in the first equation (1).

Alternatively, the processing unit 14 may comprise an artificial neural network. An input layer of the artificial neural network may be electrically connected to the input 12. An output layer of the artificial neural network may be electrically connected to the output 16.

When used with the first and second embodiment of the system, the artificial neural network may be trained such that it outputs a fluid temperature when a first temperature value and a second temperature value are provided at the input layer, directly or indirectly. The training of the artificial neural network may be performed with training data comprising sets of a first temperature value, a second temperature value and a corresponding fluid temperature value. However, different numbers of nodes and/or layers, different node types, or improved structure may be used.

The artificial neural network may for example comprise a single hidden layer with five nodes each comprising sigmoid functions. However, different numbers of nodes and/or layers, different node types, or improved structure may be used.

In operation, the first temperature value and the second temperature value may be provided to the input layer of the artificial neural network. Then, the artificial neural network provides a fluid temperature at the output layer.

If the artificial neural network is used with the third embodiment of the system, the artificial neural network may be trained such that it provides a fluid temperature when the first temperature value and the temperature values of the second sensor 28 are provided to the input layer.

The determined fluid temperature value of all embodiments is provided as an output signal. The output 16 may provide that output signal to a control unit of a vehicle, for example.

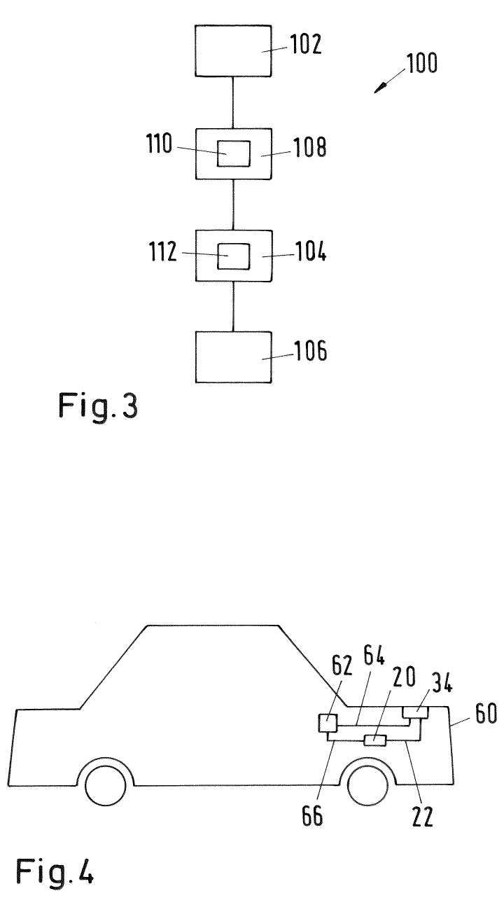

In a further embodiment, the processing unit 14 may be configured to perform the computer implemented method 100 for providing a at least one fluid temperature value of a fluid flowing in a line. FIG. 3 shows a flow chart of the method 100.

In a first step 102, the first temperature signal may be received. The first temperature signal may comprise at least one first temperature value from the first sensor 26 as described above.

In a further optional step 108, a second temperature signal may be received from the second sensor 28 as described above or from an external sensor. The second temperature value may then be determined from the second temperature signal.

If an external sensor provides the second temperature signal, the temperature of the ambient air may be extracted from the second temperature signal.

If the second sensor 28 provides the second temperature signal, in an optional sub-step 110, the temperature of the ambient air may be determined.

Step 102 and optional step 108 may be performed in any order or at the same time.

Alternatively, the second temperature value may be an estimated temperature of the ambient air of the line. Furthermore, the second temperature value may be constant.

The estimated temperature value of the ambient air of the line may be provided from a memory. The memory may for example provide the estimated temperature value as second temperature signal. Alternatively, the memory may provide the second temperature value, directly.

In a further step 104, at least one fluid temperature value may be determined from the first temperature value and the second temperature value.

In an optional step 112, the fluid temperature value may be determined via reverse calculation using at least equation (1) using the determined second temperature value, wherein R1, Ri, Rc, and Q1 are known or may be determined.

Optional step 108 and step 104 may be performed in any order or at the same time, for example by using equation (2) in equation (1).

Alternatively, if optional sub-steps 110 and 112 are omitted, the first temperature value and the second temperature value may be provided to an input layer of an artificial neural network to receive a fluid temperature value.

In a step 106, the determined fluid temperature value is provided as an output signal. The output signal may be received by a control unit, e.g. from a vehicle.

FIG. 4 shows an example of a vehicle 60. The vehicle 60 comprises a fluid line 22 and a system 20 connected to the fluid line 22. The processing unit 14 of the device 10 of the system 20 may be electrically connected to or integrated into a control unit 62 of the vehicle 60 via a signal line 66.

The vehicle 60 may comprise an air temperature sensor 34 being configured to provide ambient air temperature values from the ambient air of the line 22. The air temperature sensor 34 may be the external sensor mentioned above. Furthermore, the air temperature sensor 34 may be configured to provide the ambient air temperature values via the second temperature signal.

In an example, the control unit 62 may also receive the ambient air temperature values from the air temperature sensor 34 via a further signal line 64.

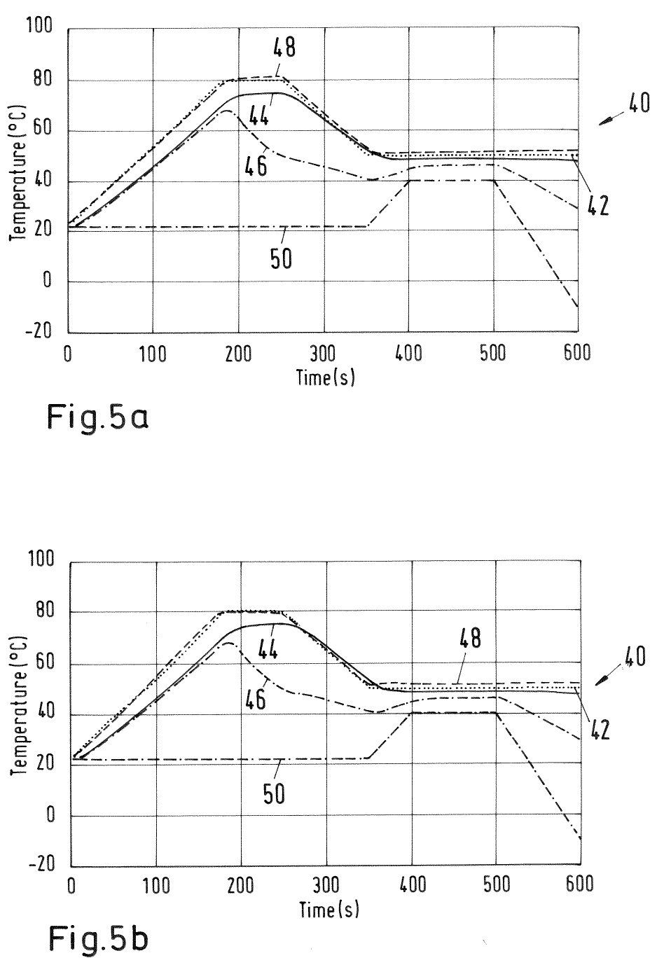

FIGS. 5a to 7b each show a diagram 40 comprising time resolved determined fluid temperature values for different embodiments of the device 10 and/or method 100.

According to FIGS. 5a and 5b, a second sensor attached to the second heat conducting element of the line being in direct contact to ambient air provides a time resolved second temperature signal shown as dash-dotted line 46. A series of first temperature values is shown as full line 44. The resulting fluid temperature values are shown as dashed line 48. The real ambient air temperature is shown as double dash dotted line 50 for information purposes. Furthermore, the real fluid temperature is shown as dotted line 42.

In FIG. 5a, both equations (1) and (2) are used to determine the fluid temperature values from the first temperature values and the second temperature signal from the second sensor.

In FIG. 5b, the first temperature value and the temperature values from the second temperature signal are provided to the artificial neural network to determine the fluid temperature values.

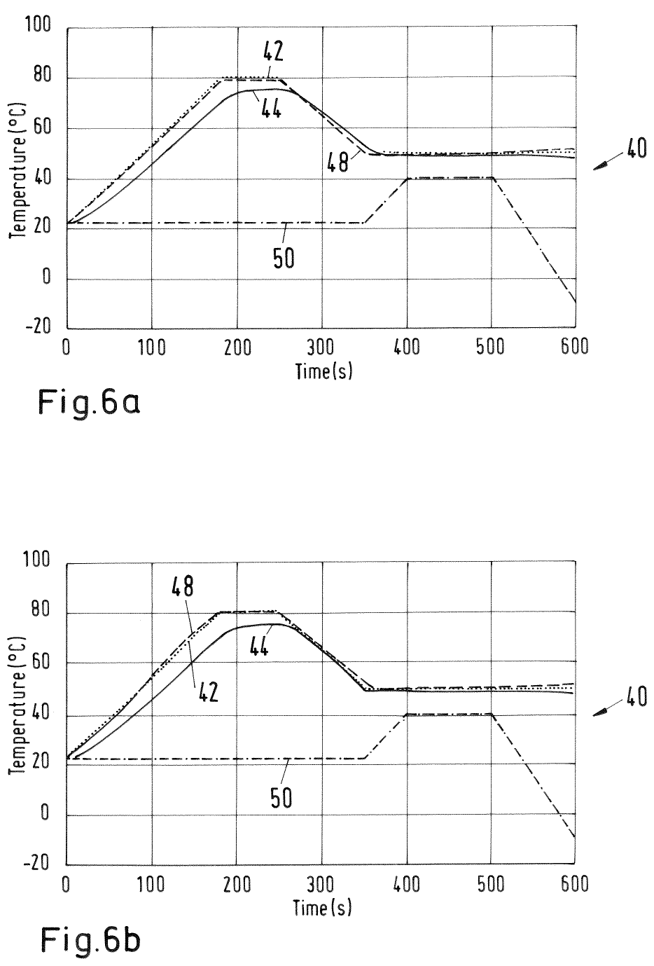

According to FIGS. 6a and 6b, the second temperature signal may result from an external sensor. In this example, the second temperature signal comprises the ambient air temperatures values as second temperature values (not shown).

In FIG. 6a, only equation (1) is used to determine the fluid temperature values from the first temperature values and the second temperature signal from the external sensor.

In FIG. 6b, the first temperature value and the second temperature values from the second temperature signal are provided to the artificial neural network to determine the fluid temperature values.

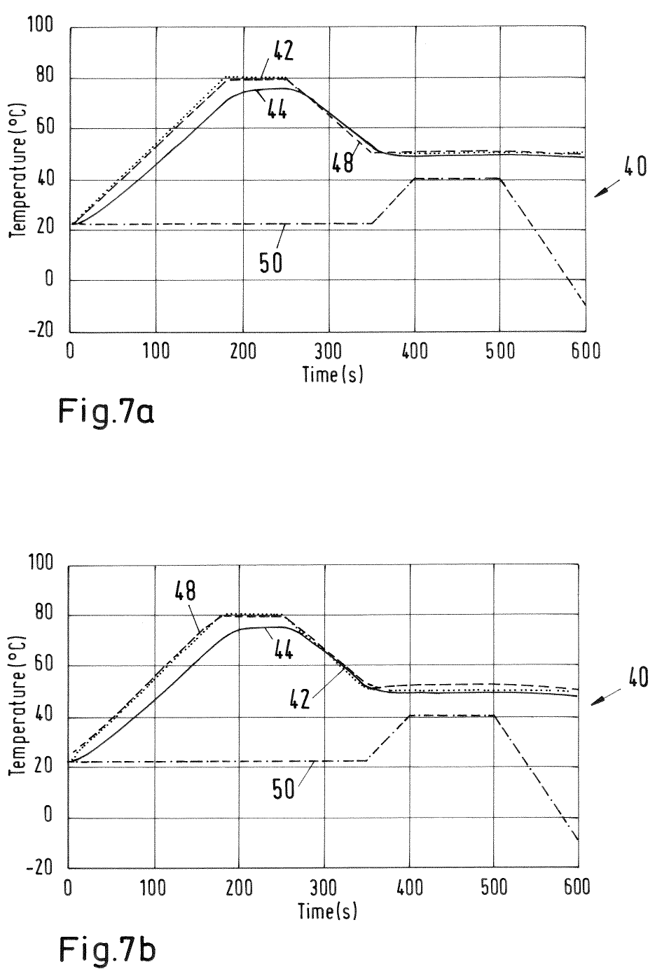

According to FIGS. 7a and 7b, the second temperature signal are estimated to be constant at 22° C. The real ambient air temperature is shown as double dash dotted line 50 for information purposes.

In FIG. 7a, only equation (1) is used to determine the fluid temperature values from the first temperature values and the second temperature signal from the external sensor.

In FIG. 7b, the first temperature value and the second temperature values from the second temperature signal are provided to the artificial neural network to determine the fluid temperature values.

In all FIGS. 5a to 7b, the determined fluid temperature values are closer to the real fluid temperature as the first temperature values that the prior art assumes as fluid temperature.

The invention is not limited to one of the aforementioned embodiments. It can be modified in many ways.

All features and advantages resulting from the claims, the description and the drawing, including constructive details, spatial arrangements and procedural steps, may be essential for the invention both in themselves and in various combinations.

Furthermore, in general, while a multitude of embodiments have been described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

List of reference numerals

| | | | |
|---|---|---|---|
| 10 | device | 12 | input |
| 14 | processing unit | 16 | output |
| 18 | signal line | 18′ | signal line |
| 20 | system | 22 | line |
| 24 | thermally insulating | 26 | first sensor |
| | element | | |
| 28 | second sensor | 30 | first heat conducting |
| | | | element |
| 34 | external sensor | 40 | diagram |
| 42 | real fluid temperature | 44 | first temperature |
| | values | | values |
| 46 | second temperature | 48 | determined fluid |
| | values | | temperature values |
| 50 | ambient air temperature | 60 | vehicle |
| | values | | |
| 62 | control unit | 64 | signal line |
| 66 | signal line | | |

1. Device for providing a at least one fluid temperature value of a fluid flowing in a line, the device comprising: an input, a processing unit and an output, wherein the input is configured to receive a first temperature signal providing at least one first temperature value from a first sensor abutting a first heat conducting element at the line, the first heat conducting element extending to the fluid in the line, wherein the output is configured to provide an output signal comprising at least one fluid temperature value, and wherein the processing unit is configured to perform at least the following steps:
Receiving the first temperature signal from the input;
Determining the at least one fluid temperature value from the first temperature value using a second temperature value representing a temperature of the ambient air of the line; and
Providing an output signal comprising the at least one fluid temperature value.

2. Device according to claim 1, wherein the second temperature value is determined from at least one second temperature signal from a second sensor directly measuring the temperature of the ambient air of the line and being in thermal contact to the ambient air of the line.

3. Device according to claim 1, wherein the processing unit is further configured to determine the at least one fluid temperature value based on the second temperature value and at least based on a heat accumulation rate in the first sensor.

4. Device according to claim 1, wherein the second temperature value is an estimated value.

5. Device according to claim 1, wherein the processing unit is further configured to provide the first temperature value and the second temperature value to an artificial neural network, wherein an output layer of the artificial neural network provides the at least one fluid temperature value.

6. System for providing a at least one fluid temperature value of a fluid flowing in a line, the system comprising at least one line for transporting a fluid, at least one device according to claim 1, at least one first sensor being attached to a first heat conducting element of the line and being arranged between the first heat conducting element and at least one thermally insulating element shielding the at least one first sensor from the ambient air, wherein the first sensor is electrically connected to the input of the device.

7. System according to claim 6, wherein the system further comprises a second sensor being attached to the first heat conducting element of the line, wherein the second sensor is in contact with the ambient air of the line.

8. Vehicle comprising at least one fluid line and at least one system according to claim 6, wherein the line is connected to the fluid line.

9. Computer implemented method for providing at least one fluid temperature value of a fluid flowing in a line, the method comprising at least the following steps:
Receiving a first temperature signal providing at least one first temperature value from a first sensor abutting a first heat conducting element at the line, the first heat conducting element extending to the fluid in the line;
Determining the at least one fluid temperature value from the first temperature value using a second temperature value representing a temperature of the ambient air of the line; and
Providing an output signal comprising the at least one fluid temperature value.

10. Method according to claim 9, wherein the second temperature value is determined from at least one second temperature signal from a second sensor directly measuring the temperature of the ambient air of the line and being in thermal contact to the ambient air of the line.

11. Method according to claim 9, characterized in that wherein the at least one fluid temperature value is determined based on the second temperature value and at least based on a heat accumulation rate in the first sensor.

12. Method according to claim 9, characterized in that wherein the second temperature value is an estimated value.

13. Method according to claim 9, characterized in that wherein in the step determining the at least one fluid temperature value, the first temperature value and the second temperature value are provided to an artificial neural network, wherein the output layer of the artificial neural network provides the at least one fluid temperature value.
